(19) United States
(12) Patent Application Publication
(10) Pub. No.: US 2012/0252972 A1
(43) Pub. Date: Oct. 4, 2012

(54) AQUEOUS MULTISTAGE POLYMER DISPERSION, PROCESS FOR ITS PREPARATION, AND USE THEREOF AS BINDER FOR COATING SUBSTRATES

(75) Inventors: Roelof BALK, Bohl-Iggelheim (DE); Arno Tuchbreiter, Charlotte Unit, NC (US); Bas Lohmeijer, Mannheim (DE)

(73) Assignee: BASF SE, Ludwigshafen (DE)

(21) Appl. No.: 13/432,423

(22) Filed: Mar. 28, 2012

Related U.S. Application Data
(60) Provisional application No. 61/469,120, filed on Mar. 30, 2011.

(51) Int. Cl. C09D 133/10; C08F 2/22; C09D 133/26; C09D 15/00; C09D 139/04; C09D 133/14

(52) U.S. Cl. 524/809; 524/816; 524/833; 524/831

(57) ABSTRACT

The present invention provides multistage aqueous polymer dispersions which are film-forming at low temperatures, exhibit good blocking resistance in a formulation, even at elevated temperatures, display low foam propensity, and possess good wet adhesion and shelf life, processes for their preparation, and the use thereof as binders for coating substrates.

The present invention provides multistage aqueous polymer dispersions which are film-forming at low temperatures, exhibit good blocking resistance in a formulation, even at elevated temperatures, display low foam propensity, and possess good wet adhesion and shelf life, processes for their preparation, and the use thereof as binders for coating substrates.

Aqueous polymer dispersions are common knowledge. They are fluid systems which comprise, in disperse distribution as a disperse phase in the aqueous dispersion medium, polymer coils which are composed of a plurality of intertwined polymer chains, these coils being referred to as the polymer matrix or polymer particles. The average diameter of the polymer particles is frequently in the range from 10 to 1000 nm, more preferably in the range from 30 to 300 nm. Aqueous polymer dispersions are used as binders across a host of industrial applications.

Where they are used as binders for coatings on substrates, one of the important requirements of such coatings is that they possess high hardness and hence exhibit good scratch resistance and blocking resistance. For environmental reasons, filming of the binder in the range from <0 to 40° C. is desired, and so only small amounts of a film-forming assistant, or none, are required. Another requirement is a high level of fine division. This allows the preparation of transparent aqueous stains and permits effective penetration of the stain into the substrate, particularly when the substrate to be coated is wood.

From EP-B 0 710 680 it is known that, by means of multistage emulsion polymerization, it is possible to prepare polymer dispersions which have a low minimum film-forming temperature (MFFT) and form films having high blocking resistance. Such polymer dispersions have an average polymer particle diameter of <100 nm. The fine division, however, is not enough in the majority of cases for the formulation therewith in the wet state of desired transparent stains for wood coatings. Wood stains form coatings on wood that are transparent or semitransparent in the dry state. They comprise transparent pigments (e.g., transparent, ultrafine iron oxide) in so small an amount that the structure of the wood is still visible.

Where the particle size of the polymer particles to be prepared by means of the radically initiated aqueous emulsion polymerization is to be set specifically, it is usual to use what is called a polymer seed, which either has been prepared separately beforehand with other monomers (exogenous polymer seed) or which has been generated by partial polymerization of the monomers to be polymerized, in situ. Particularly in the context of the preparation of finely divided polymer dispersions, it is preferred to use this in situ polymer seed.

The preparation of an aqueous polymer dispersion using an in situ polymer seed is familiar to the skilled person (see, for example, DE-A 196 09 509, EP-A 690882, EP-A 710 680, EP-A 1 125 949, EP-A 1 294 816, EP-A 1 614 732, WO-A 03/29300) and is generally accomplished by introducing, before the emulsion polymerization proper, a small portion of one of the monomers used for the emulsion polymerization, or of the monomer mixture used for the emulsion polymerization, as an initial charge in the aqueous polymerization medium, and subjecting it to free-radical polymerization in the presence of a relatively large quantity of emulsifier. If especially finely divided polymer dispersions are needed, a particularly large quantity of emulsifier is required. The foam-forming propensity of the polymer dispersions, which as a result are very rich in emulsifier, is high.

One elegant way of saving on emulsifier during preparation and processing, while retaining the stability, is to prepare “invert” or “inverted” core-shell polymers. Such polymers were described as far back as in EP 338486, and in references cited therein. In these cases, a carboxyl-rich monomer composition is first polymerized by means of a ‘conventional’ emulsion polymerization procedure, often in the presence of a small amount of emulsifier and a chain transfer agent, which, following a ‘swelling step’ with aqueous alkali (U.S. Pat. No. 5,081,166) or complete neutralization of the carboxyl groups and dissolution of the polymer particles (EP 758347), functions as a stabilizer for the next polymerization steps (see also EP 989163, EP 1978044, US 2008/0058473-A1). For polymers of this kind, in the first monomer composition, in general, fairly high quantities of monomers which carry carboxyl groups, or monomers with latent carboxyl functionality, are used. In WO 05/121595, for example, 10%-70% by weight of latent carboxyl-functional monomers are used in the first polymer stage, based on 100% by weight of the 1st stage. If such polymers are used as binders in aqueous formulations, which are often formulated to a pH>8 with thickeners, more particularly with acrylate thickeners, in order to produce the desired flow behavior in the formulations, such high carboxyl functionality results in instability on the part of such formulations when they are stored, as manifested in an uncontrolled viscosity increase or sedimentation.

It was an object of the present invention to provide stable polymer dispersions with little emulsifier for coating compositions which exhibit very good film-forming even at low temperatures and yet produce films having a high hardness and excellent blocking resistance and distinguished, furthermore, by good wet adhesion and shelf life.

The object has been achieved by means of a polymer dispersion obtainable by at least two-stage emulsion polymerization
where first of all in a first stage in aqueous medium a first polymer in dispersion in water and having a glass transition temperature of more than 50° C. and a weight-average molecular weight of between 5 and 100 kDa is prepared by free-radical emulsion polymerization from a first composition comprising hydrophilic and hydrophobic monomers,
comprising
(A1) at least one (meth)acrylic acid alkyl ester,
(B1) optionally at least one vinylaromatic having up to 20 C atoms,
(C1) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D1) at least one α,β-ethylenically unsaturated carboxylic acid, or a vinyl monomer with latent ionic groups,
(E1) optionally at least one crosslinker,
(F1) at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G1) optionally at least one compound having a (meth)acrylate group and an epoxy group, and
(H1) optionally at least one α,β-ethylenically unsaturated carboxamide,
   in the presence of at least one initiator, at least one emulsifier, and at least one chain transfer agent,
neutralization to a pH of at least 4.5, preferably greater than 5.5, of the particles thus formed, using a base (neutralizing agent),
followed by free-radical polymerization of hydrophobic and hydrophilic monomers in a following stage, in the presence of the copolymer prepared in the first stage, from
(A2) at least one (meth)acrylic acid alkyl ester,
(B2) optionally at least one vinylaromatic having up to 20 C atoms,
(C2) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D2) optionally at least one α,β-ethylenically unsaturated carboxylic acid, or a vinyl monomer with latent ionic groups,
(E2) optionally at least one crosslinker, and
(F2) optionally at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G2) optionally at least one compound having a (meth)acrylate group and an epoxy group, and
(H2) optionally at least one α,β-ethylenically unsaturated carboxamide, with the proviso that the polymer of the 2nd stage is more hydrophobic than that of the 1st stage, and the glass transition temperature of the second stage is at least 50° C. lower than that of the first stage.
The expression “more hydrophobic” means that the polymer of the 2nd stage must have significantly lower solubility parameters, as defined in Van Krevelen in “Properties of Polymers” (Elsevier Scientific Publishing Company, Amsterdam, 1990).
This following stage may be carried out either continuously, in the form of a single monomer combination, or else in stages with different combinations.

Optionally it is possible subsequently to add, in addition, at least one further crosslinking agent.

The amount of the at least one emulsifier is 0.1% to 3.5% by weight, based on the total amount of the free-radically polymerizable monomers introduced into the free-radical polymerization in all stages.

The vinyl monomers used comprise monomers having functional groups such as crosslinking groups and hydrophilic, water-dispersible groups. Certain functional groups may have more than one function. (Meth)acrylic acid, for example, is normally used as a water-dispersible monomer, but here may also act as a crosslinking monomer and may react, for example, with epoxide compounds or carbodiimides.

The invention further provides a coating composition comprising the polymer dispersion of the invention.

In the polymerization it is possible in accordance with the invention to use the following monomers:

### (Meth)Acrylic Acid Alkyl Esters (A1) and (A2)

This encompasses preferably those (meth)acrylic acid alkyl esters whose linear or branched alkyl radical has 1 to 20 carbon atoms, more preferably 1 to 10, very preferably 1 to 8, and more particularly 1 to 4 carbon atoms.

Examples of (meth)acrylic acid alkyl esters include methyl(meth)acrylate, ethyl(meth)acrylate, n-propyl(meth)acrylate, n-butyl(meth)acrylate, isobutyl(meth)acrylate, sec-butyl (meth)acrylate, tert-butyl(meth)acrylate, n-pentyl(meth)acrylate, isopentyl(meth)acrylate, 2-methylbutyl(meth)acrylate, amyl(meth)acrylate, n-hexyl(meth)acrylate, 2-ethylbutyl (meth)acrylate, pentyl(meth)acrylate, n-heptyl(meth)acrylate, n-octyl(meth)acrylate, 2-ethylhexyl(meth)acrylate, 2-propylheptyl(meth)acrylate, n-decyl(meth)acrylate, undecyl (meth)acrylate, and n-dodecyl(meth)acrylate.

Preference is given to methyl methacrylate, methyl acrylate, ethyl acrylate, n-butyl acrylate, n-butyl methacrylate, n-hexyl acrylate, n-octyl acrylate, 2-ethylhexyl acrylate, and 3-propylheptyl acrylate.

Also suitable in particular are mixtures of the (meth)acrylic acid alkyl esters.

### Vinylaromatics Having Up to 20 C Atoms (B1) and (B2)

These are optionally substituted aromatic systems having a vinyl group which is in conjugation to the aromatic ring system.

Such substituted vinylaromatics have one or more, preferably 1, linear or branched alkyl group or groups having 1 to 10 carbon atoms, preferably 1 to 6 and more preferably 1 to 4 carbon atoms, it being possible for this or these alkyl groups to be located on the aromatic or on the vinyl group. Where the substituent is on the aromatic, the substituent may be located preferably in ortho- or para-position, more preferably in para-position to the vinyl group.

Suitable vinylaromatic compounds include vinyltoluene, vinylnaphthalene, α- and p-methylstyrene, α-butylstyrene, 4-n-butylstyrene, 4-n-decylstyrene, and, preferably, styrene and α-methylstyrene.

### Free-Radically Polymerizable Compound (C1) and (C2)

The compounds (C1) and (C2) are selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols comprising 1 to 10 C atoms, are preferably selected from the group consisting of ethylenically unsaturated nitriles having up to 20 C atoms and vinyl ethers of alcohols comprising 1 to 10 C atoms, and more preferably are ethylenically unsaturated nitriles having up to 20 C atoms.

### Ethylenically Unsaturated Nitriles Having Up to 20 C Atoms

Examples of ethylenically unsaturated nitriles are fumaronitrile, acrylonitrile, and methacrylonitrile, preferably acrylonitrile and methacrylonitrile, and more preferably acrylonitrile.

### Vinyl Esters of Carboxylic Acids Comprising Up to 20 C Atoms

Vinyl esters of carboxylic acids having 1 to 20 C atoms are, for example, vinyl laurate, vinyl stearate, vinyl propionate, Versatic acid vinyl esters, vinyl butyrate, and vinyl acetate, preferably vinyl acetate.

### Vinyl Halides Having Up to 10 C Atoms

The vinyl halides are ethylenically unsaturated compounds substituted by chlorine, fluorine or bromine, preferably vinyl chloride and vinylidene chloride.

### Vinyl Ethers of Alcohols Comprising 1 to 10 C Atoms

Examples of vinyl ethers include methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, and n-octyl vinyl ether. Vinyl ethers of alcohols comprising 1 to 4 C atoms are preferred.

### α,β-Ethylenically Unsaturated Carboxylic Acid (D1) and (D2)

These are α,β-ethylenically unsaturated carboxylic acids having 3 to 10, preferably 3 to 6, more preferably 3 to 4 carbon atoms.

Optionally the ionic groups may also be latent, as in maleic anhydride, for example, where the acid functionality is present in the form of an anhydride group.

Preference is given to (meth)acrylic acid, crotonic acid or dicarboxylic acids, e.g., itaconic acid, maleic acid or fumaric acid, more preferably methacrylic acid and acrylic acid.

(Meth)acrylic acid in this description stands for methacrylic acid and acrylic acid.

### Crosslinkers (E1) and (E2)

Crosslinkers are those which have at least two free-radically polymerizable double bonds, preferably 2 to 6, more preferably 2 to 4, very preferably 2 to 3, and more particularly exactly 2.

Examples of di- and poly(meth)acrylates include 1,2-, 1,3-, and 1,4-butanediol diacrylate, 1,2- and 1,3-propylene glycol (meth)acrylate, 1,6-hexanediol di(meth)acrylate, 1,2-ethylene glycol di(meth)acrylate, neopentylglycol di(meth)acrylate, diethylene glycoldi(meth)acrylate, triethylene glycoldi(meth)acrylate, tetraethylene glycoldi(meth)acrylate, trimethylolpropane tri(meth)acrylate, trimethylolethane tri(meth)acrylate, and pentaerythritol tri- and tetra(meth)acrylate.

Mention may also be made of divinylbenzene and allyl(meth)acrylate.

Compounds (F1) and (F2) are selected from the group consisting of 2-(2-oxoimidazolidin-1-yl)ethyl(meth)acrylate, 2-ureido(meth)acrylate, N-[2-(2-oxooxazolidin-3-yl)ethyl]methacrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide.

Preference is given to 2-(2-oxoimidazolidin-1-yl)ethyl(meth)acrylate, (acetoacetoxy)ethyl methacrylate, and diacetoneacrylamide, particular preference to diacetoneacrylamide.

If compounds (F1) and (F2) are used, they are used preferably in the first stage and not in the second stage; in other words, if the amount of ((F1)+(F2))≠0, then preferably the amount of (F1)≠0 and (F2)=0.

### (G1) and (G2)

These compounds comprise at least one compound having a (meth)acrylate and an epoxy group. Particularly noteworthy are glycidyl acrylate and glycidyl methacrylate, preferably glycidyl methacrylate.

### (H1) and (H2)

These compounds comprise at least one α,β-ethylenically unsaturated carboxamide.

Particular preference is given to (meth)acrylamide, crotonamide or amides of dicarboxylic acids, for example, itaconamide, maleamide or fumaramide, more preferably methacrylamide and acrylamide.

If compounds (H1) and (H2) are used, they are used preferably in the first stage and not in the second stage; in other words, if the amount of ((H1)+(H2))≠0, then preferably the amount of (H1)≠0 and (H2)=0.

It is additionally possible to use in minor amounts, as for example at less than 5% by weight, preferably less than 3% by weight, more preferably less than 1% by weight, monomers other than those recited above.

Examples of these further monomers are phosphorus-containing monomers, examples being vinylphosphonic acid and allylphosphonic acid. Also suitable are the monoesters and diesters of phosphonic acid and phosphoric acid with hydroxyalkyl(meth)acrylates, especially the monoesters. Also suitable are diesters of phosphonic acid and phosphoric acid which are esterified singly with a hydroxyalkyl(meth)acrylate and also singly with a different alcohol, such as an alkanol. Suitable hydroxyalkyl(meth)acrylates for these esters are those specified as separate monomers below, especially 2-hydroxyethyl(meth)acrylate, 3-hydroxypropyl (meth)acrylate, 4-hydroxybutyl(meth)acrylate, etc. Corresponding dihydrogenphosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Also suitable are phospho-alkyl crotonates, phosphoalkyl maleates, phosphoalkyl fumarates, phosphodialkyl(meth)-acrylates, phosphodialkyl crotonates, and allyl phosphates. Other suitable monomers containing phosphorus groups are described in WO 99/25780 and U.S. Pat. No. 4,733,005, hereby incorporated by reference.

Also suitable are vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, and 2-acrylamido-2-methylpropanesulfonic acid. Suitable styrenesulfonic acids and derivatives thereof are styrene-4-sulfonic acid and styrene-3-sulfonic acid and the alkali metal or alkaline earth metal salts thereof, e.g., sodium styrene-3-sulfonate and sodium styrene-4-sulfonate, poly(allyl glycidyl ethers) and mixtures thereof, in the form of various products with the name Bisomer® from Laporte Performance Chemicals, UK. These include, for example, Bisomer® MPEG 350 MA, a methoxypolyethylene glycol monomethacrylate.

The functional groups of the monomers contribute to mediating the latent crosslinkability of the composition. Crosslinking in this case takes place either by reaction with one another or by addition of a further crosslinking agent. Crosslinking preferably takes place only after actual film formation.

In this context it is important not to use too much additional crosslinking agent, since this may lead to residual crosslinking agent leftovers. Too little crosslinking agent, on the other hand, may lead to a soluble coating.

Functional crosslinker groups are, for example, keto groups, aldehyde groups and/or acetoacetoxy carbonyl groups, and the formulated crosslinking agents added subsequently may comprise a polyamine or polyhydrazide such as adipic dihydrazide (ADDH), oxalic dihydrazide, phthalic dihydrazide, terephthalic dihydrazide, isophoronediamine, and 4,7-dioxadecane-1,1-O-diamine, or a crosslinking agent which carries semicarbazide or hydrazine-functional groups. Alternatively the polymer could carry hydrazide-functional groups and the subsequently formulated crosslinking agent could comprise keto-functional groups.

The functional groups may also be carboxyl functions, and the subsequently formulated crosslinking agent could comprise aziridine groups, epoxide groups or carbodiimide-functional groups, or the functional groups may be silane-functional groups and the subsequently formulated crosslinking agent may likewise comprise silane-functional groups. Functional groups can also be ureido groups, and the subsequently added crosslinking agent may be a polyaldehyde, as for example an α,ω-dialdehyde having one to ten C atoms, such as glyoxal, glutardialdehyde or malondialdehyde, and/or their acetals and hemiacetals. See EP 0789724.

Also possible, of course, are combinations of the various functional groups and crosslinking mechanisms.

Examples of vinyl monomers comprising crosslinking groups are allyl, glycidyl or acetoacetoxy esters, acetoacetoxyamides, keto- and aldehyde-functional vinyl monomers, keto-containing amides such as diacetoneacrylamide, (meth)acrylic silane monomers.

Preferred vinyl monomers which carry crosslinking groups are acetoacetoxyethyl methacrylate (AAEM), diacetoneacrylamide (DAAM), and (meth)acrylic silane monomers; DAAM is the most preferred.

Preferred crosslinking mechanisms comprise crosslinking of silane-functional groups and crosslinking of keto-functional with hydrazide-functional groups.

The most preferred is the combination of DAAM and ADDH crosslinking.

The polymer of the first stage is not water-soluble but dispersed in water at low pH levels of, for example, 2 to 3 and with acid groups not neutralized. If base is added during or before and during the polymerization of the second stage, the hydrophilicity and water-solubility of the first-stage polymer increases successively in line with the increasing degree of neutralization of the acid groups. As the hydrophilicity and water-solubility go up, the polymer of the first stage is able to act increasingly as a protective colloid for the polymer of the second stage and, toward the end of the polymerization, to stabilize the polymer dispersion with high polymer solids content. Protective colloids are polymeric compounds which bind large quantities of water on solvation and are capable of stabilizing dispersions of water-insoluble polymers.

The polymers of the first stage which become active as protective colloids on neutralization are used preferably in an amount of 5% to 95%, more preferably 7% to 80% and very preferably 10% to 50%, by weight, based on 100% by weight of the monomers to be polymerized.

In one preferred embodiment the polymer of the first stage is a copolymer
(i) which is used in an amount of 7% to 80% by weight, based on 100 parts by weight of the total monomers for polymerization in the first and second stages,
(ii) which is synthesized to an extent of at least, e.g., 50% or 60% by weight and up to 99% by weight of principal monomers which are selected from the group of the monomers A1 and B1 and
(iii) 0.1% to 10% by weight of at least one α,β-ethylenically unsaturated carboxylic acid, or vinyl monomer with latent ionic groups (monomers D1),
(iv) 0.1% to 10% by weight of at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM) and diacetonemethacrylamide (monomers F1),
(v) 0% to 10% by weight of at least one compound selected from the group of an α,β-ethylenically unsaturated carboxamide (monomers H1),
(vi) 0% to 10% by weight of at least one compound selected from the monomers C1, E1, and G1,
   the quantity figures (ii) to (vi) being based in each case on 100% by weight of the monomers for polymerization in the first stage.

In one preferred embodiment of the invention at least one molecular weight regulator (chain transfer agent) is used in the polymerization of the first stage. By this means it is possible to reduce the molar mass of the emulsion polymer, through a chain termination reaction. The regulators here are attached to the polymer, generally to the chain end. The amount of the regulators is in particular 0.05 to 4 parts by weight, more preferably 0.05 to 2 parts by weight, per 100 parts by weight of the total monomers for polymerization in the first and second stages. Suitable regulators are, for example, compounds with a thiol group such as tert-butyl mercaptan, alkyl esters of thioglycolic acid, mercaptoethanol, mercaptopropionic acid, mercaptopropyltrimethoxysilane, and n- or tert-dodecyl mercaptan. The regulators are generally compounds of low molecular weight, having a molar weight of less than 2000, more particularly less than 1000 g/mol.

The neutralization performed subsequent to the first stage takes place with a base. The base leads to partial or complete neutralization of the ionic or latently ionic groups of the polymer of the first stage; it can lead to swelling of the polymer particles, but may also convert them completely into solution. It is preferred to carry out only a partial neutralization, of up to 80%, for example, of the ionic or latently ionic groups present. Examples of bases which can be used include alkali metal or alkaline earth metal compounds such as sodium hydroxide, potassium hydroxide, calcium hydroxide, magnesium oxide, sodium carbonate; ammonia; primary, secondary, and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, dimethylaminopropylamine, neopentanediamine, hexamethylenediamine, 4,9-dioxadodecane-1,12-diamine, polyethyleneimine or polyvinylamine.

The acid groups of the polymer of the first stage may be neutralized partially or completely with suitable bases. It is preferred to use aqueous sodium hydroxide solution, aqueous potassium hydroxide solution or ammonia as neutralizing agent.

In one embodiment of the invention the polymerization of the first stage takes place by means of the method of the in situ seed mode. For this method, a portion of a monomer or of the monomer mixture of the first stage, <35% by weight for example, preferably <20% by weight, based on the total weight of the monomers of the first stage, is included in the initial charge together with emulsifier, for example <10% by weight, preferably <3% by weight, based on the total weight of the monomers of the first stage, and subjected to initial polymerization by means of an initiator, after which the remainder of the first stage is metered in.

The monomers used for the polymerization of the second stage comprise preferably to an extent of at least 60% by weight, more preferably at least 80% by weight, e.g., from 80% to 100% by weight, more preferably at least 90% by weight, or 100% by weight, based on the total amount of the monomers of the second stage, of the principal monomers A2 and/or B2. Especially preferred are methyl acrylate, methyl methacrylate, ethyl acrylate, n-butyl acrylate, n-butyl methacrylate, n-hexyl acrylate, octyl acrylate, 2-ethylhexyl acrylate, 2-propylheptyl acrylate, styrene, and mixtures of these monomers.

The addition of the monomers of the second stage may take place in accordance with a gradient mode. By the gradient mode for the purposes of the present invention is meant an emulsion polymerization in which one or more monomers are metered in at a nonconstant rate. For reasons of ease of apparatus operation, in the case of the experiments described here, the rates were varied not continuously (i.e., true gradient) but rather in stages (i.e., interpolated gradient) (in the mathematical sense, therefore, the plot of the metering rate against time represents a noncontinuous function). Continuous rate changes, however, are in principle also operable without substantial extra effort or complexity.

In one embodiment, the monomer with at least one acid group that is used in the first stage, D1, is methacrylic acid; the monomer F1 used is diacetoneacrylamide; and the further monomers used in the first stage, A1 and/or B1, are selected from 2-ethylhexyl acrylate, n-butyl acrylate, n-butyl methacrylate, methyl acrylate, methyl methacrylate, styrene, and a mixture thereof; and at least 80% by weight of the monomers A2 and/or B2 used in the second stage are selected from the group consisting of C1 to C10 alkyl acrylates, C1 to C10 alkyl methacrylates, styrene, and a mixture thereof. Subsequently adipic dihydrazide is added as additional crosslinking agent.

The weight-average molecular weight of the monomers of the polymerization of the first stage is between 5 and 100 kDa, preferably between 10 and 50 kDa. The monomers of the polymerization of the first stage are selected such that the glass transition temperature calculated for a polymer prepared from the monomers of the first stage is greater than 50° C., more particularly in the range from 50° C. to 150° C. or in the range from 70° C. to 125° C.

Through skilful variation in nature and amount of the monomers it is possible in accordance with the invention for the skilled person to prepare aqueous polymer compositions whose polymers have a glass transition temperature within the desired range. Rangefinding is possible by means of the Fox equation. According to Fox (T. G. Fox, Bull. Am. Phys. Soc. 1956 [Ser. II] 1, page 123 and in accordance with Ullmann's Encyclopädie der technischen Chemie, vol. 19, page 18, 4th edition, Verlag Chemie, Weinheim, 1980), for a calculation of the glass transition temperature of copolymers, the following holds in good approximation:

1/T_{g}=x¹/T_{g}+x²/T_{g}²+ . . . xⁿ/T_{g}ⁿ,

where x¹, x², . . . xⁿ are the mass fractions of monomers 1, 2, . . . n, and T_{g}¹, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed in, for example, Ullmann's Encyclopedia of Industrial Chemistry, 5th edn., vol. A21, page 169, VCH Weinheim, 1992; other sources of homopolymer glass transition temperatures include, for example, J. Brandrup, E. H. Immergut, Polymer Handbook, 1^{st} edn., J. Wiley, New York 1966, 2^{nd} edn. J. Wiley, New York 1975, and 3^{rd} edn., J. Wiley, New York 1989. For ethyl acrylate a figure of −13° C. is used.

The monomers of the polymerization of the second stage are selected such that the glass transition temperature calculated for a polymer prepared from the monomers of the second stage is at least 50° C. lower than that of the first stage, preferably in the region of less than 10° C., more particularly in the region from 0° C. to −80° C.

The weight ratio of the amount of the monomers used in the first stage to the amount of the monomers used in the second stage is preferably from 5:95 to 95:5 or from 7:93 to 80:20, more preferably from 10:90 to 50:50.

The polymer dispersion of the invention is prepared by emulsion polymerization. In emulsion polymerization, ethylenically unsaturated compounds (monomers) are polymerized in water, typically using ionic and/or nonionic emulsifiers and/or protective colloids, or stabilizers, as interface-active compounds to stabilize the monomer droplets and the polymer particles subsequently formed from the monomers. In accordance with the invention, however, both the first-stage polymerization and the second-stage polymerization take place with low emulsifiers content or with complete or virtual absence of emulsifier. Overall, preferably, less than 2.5% by weight or less than 2.0% by weight of emulsifiers is used, more particularly less than 1.5% by weight, based on the solids content of the polymer dispersion. For stabilizing the polymer dispersion formed in the second-stage polymerization, the polymer of the first stage is used, which is converted in situ, by addition of neutralizing agent, from a water-insoluble polymer with no protective colloid activity into a water-soluble or water-swollen polymer which is active as a protective colloid.

The polymer dispersion is prepared typically in the presence of at least one interface-active compound. A comprehensive description of suitable protective colloids is found in Houben-Weyl, Methoden der organischen Chemie, volume XIV/1, Makromolekulare Stoffe [Macromolecular compounds], Georg Thieme Verlag, Stuttgart, 1961, pp. 411 to 420. Suitable emulsifiers are also found in Houben-Weyl, Methoden der organischen Chemie, Band 14/1, Makromolekulare Stoffe [Macromolecular compounds], Georg Thieme Verlag, Stuttgart, 1961, pages 192 to 208.

Suitable emulsifiers include anionic, cationic, and nonionic emulsifiers. As interface-active substances it is preferred to use emulsifiers, whose relative molecular weights are typically below those of protective colloids. More particularly it has been found appropriate to use exclusively anionic emulsifiers, or a combination of at least one anionic emulsifier and at least one nonionic emulsifier.

Useful nonionic emulsifiers are araliphatic or aliphatic nonionic emulsifiers, examples being ethoxylated mono-, di-, and tri-alkylphenols (EO degree: 3 to 50, alkyl radical: C₄-C₁₀, ethoxylates of long-chain alcohols (EO degree: 3 to 100, alkyl radical: C₈-C₃₆), and polyethylene oxide/polypropylene oxide homopolymers and copolymers. These polymers may comprise the copolymerized alkylene oxide units in random distribution or in the form of blocks. EO/PO block copolymers, for example, are very suitable. Preference is given to ethoxylates of long-chain alkanols (alkyl radical C₁-C₃₀, average degree of ethoxylation 5 to 100) and, of these, particular preference to those having a linear C₁₂-C₂₀ alkyl radical and an average degree of ethoxylation of 10 to 50, and also to ethoxylated monoalkylphenols, for use.

Examples of suitable anionic emulsifiers are alkali metal salts and ammonium salts of alkyl sulfates (alkyl radical: C₈-C₂₂), of sulfuric monoesters with ethoxylated alkanols (EO degree: 2 to 50, alkyl radical: C₁₂-C₁₈) and with ethoxylated alkylphenols (EO degree: 3 to 50, alkyl radical: C₄-C₉), of alkylsulfonic acids (alkyl radical: C12-C18) and of alkylarylsulfonic acids (alkyl radical: C₉-C₁₈). Other suitable emulsifiers are found in Houben-Weyl, Methoden der organischen Chemie, volume XIV/1, Makromolekulare Stoffe [Macromolecular compounds], Georg-Thieme-Verlag, Stuttgart, 1961, pp. 192-208. Suitable anionic emulsifiers are likewise bis(phenylsulfonic acid) ethers and their alkali metal salts or ammonium salts which carry a C₄-C₂₄ alkyl group on one or both aromatic rings. These compounds are common knowledge, from U.S. Pat. No. 4,269,749, for example, and are available commercially, in the form, for example, of Dowfax® 2A1 (Dow Chemical Company).

Suitable cationic emulsifiers are preferably quaternary ammonium halides, examples being trimethylcetylammonium chloride, methyltrioctylammonium chloride, benzyltriethylammonium chloride or quaternary compounds of N—C₆-C₂₀-alkyl-pyridines, -morpholines or -imidazoles, e.g. N-laurylpyridinium chloride.

The polymer dispersions may additionally be admixed with customary auxiliaries and additives. These include, for example, pH modifiers, reducing agents, and bleaches, such as the alkali metal salts of hydroxymethanesulfinic acid (e.g., Rongalit® C from BASF Aktiengesellschaft), complexing agents, deodorants, odorants, and viscosity modifiers, such as alcohols, e.g., glycerol, methanol, ethanol, tert-butanol, glycol, etc. These auxiliaries and additives may be added to the polymer dispersions in the initial charge, in one of the feeds, or after the end of the polymerization.

The neutralization of acid groups in the first polymer is accomplished preferably by at least partial feed addition of a neutralizing agent before and/or during the polymerization of the second stage. The neutralizing agent here may be added in a joint feed with the monomers to be polymerized, or in a separate feed. After all of the 2nd-stage monomers have been fed in, there is preferably the amount of neutralizing agent needed to neutralize at least 10%, preferably 25% to 100% or 50% to 95% acid equivalents present in the polymerization vessel.

The emulsion polymerization of the first and second stages may be initiated using water-soluble initiators. Water-soluble initiators are, for example, ammonium salts and alkali metal salts of perododisulfuric acid, e.g., sodium peroxodisulfate, hydrogen peroxide or organic peroxides, e.g., tert-butyl hydroperoxide. Also suitable as initiators are what are called reduction-oxidation (redox) initiator systems. The redox initiator systems consist of at least one, usually inorganic, reducing agent and one organic or inorganic oxidizing agent. The oxidizing component comprises, for example, the initiators already referred to above for the emulsion polymerization. The reducing component comprises, for example, alkali metal salts of sulfurous acid, such as sodium sulfite, for example, sodium hydrogensulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to occur in a plurality of valence states, Typical redox initiator systems are, for example, ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures, an example being a mixture of the sodium salt of hydroxymethanesulfinic acid and sodium disulfite.

The stated initiators are used usually in the form of aqueous solutions, with the lower concentration being determined by the amount of water acceptable in the dispersion and the upper concentration by the solubility of the respective compound in water. In general the concentration of the initiators is 0.1% to 30% by weight, preferably 0.2 to 20% by weight, more preferably 0.3% to 10% by weight, based on the monomers to be polymerized. It is also possible for two or more different initiators to be used for the emulsion polymerization.

In the polymerization of the second stage, the molecular weight regulators (chain transfer agents) identified above can be used. Preferably, however, the polymerization of the second stage takes place without addition of further molecular weight regulators. The emulsion polymerization takes place in general at 30 to 130° C., preferably at 50 to 90° C. The polymerization medium may consist either only of water, or else of mixtures of water and water-miscible liquids such as methanol. It is preferred to use just water. The emulsion polymerization of the first stage may be carried out as a batch operation or in the form of a feed process, including stage or gradient regimes.

The emulsion polymerization of the second stage as well may be carried out either as a batch operation or in the form of a feed process, including stage or gradient regimes.

The manner in which the initiator is added to the polymerization vessel in the course of the free-radical aqueous emulsion polymerization is familiar to a person of ordinary skill in the art. It may either be included in its entirety in the initial charge to the polymerization vessel, or else used continuously or in stages at the rate at which it is consumed in the course of the free-radical aqueous emulsion polymerization. In each individual case, this will be dependent on the chemical nature of the initiator system and also on the polymerization temperature. It is preferred to include part in the initial charge and to supply the remainder at the rate of its consumption to the polymerization zone. For the removal of residual monomers, it is common even after the end of the emulsion polymerization proper, in other words after a monomer conversion of at least 95%, to add initiator. In the case of the feed process, the individual components may be added to the reactor from the top, in the side or from below, through the reactor bottom.

Frequently it is advantageous if the aqueous polymer dispersion obtained after the end of the polymerization stages is subjected to an aftertreatment for the purpose of reducing the residual monomer content. This aftertreatment takes place chemically, as for example by completion of the polymerization reaction through the use of a more effective free-radical initiator system (referred to as post polymerization), and/or physically, as for example by stripping of the aqueous polymer dispersion using steam or inert gas. Corresponding chemical and/or physical methods are familiar to the skilled person [see, for example, EP-A 771 328, DE-A 196 24 299, DE-A 196 21 027, DE-A 197 41 184, DE-A 197 41 187, DE-A 198 05 122, DE-A 198 28 183, DE-A 198 39 199, DE-A 198 40 586, and 198 47 115]. The combination of chemical and physical after-treatment here affords the advantage that not only the unreacted ethylenically unsaturated monomers but also other disruptive VOCs [volatile organic compounds] are removed from the aqueous polymer dispersion. The dispersions of the invention are preferably not chemically aftertreated.

The aqueous polymer dispersions obtainable in accordance with the process of the invention have polymer particles which possess a weight-average particle diameter D_{w} in the range ≧10 and ≦500 nm, preferably ≧20 and ≦200 nm, and with particular preference ≧20 nm to ≦100 nm. The determination of the weight-average particle diameters is known to the skilled person and is accomplished, for example, by the method of the analytical ultracentrifuge. The weight-average particle diameter in this specification refers to the weight-average D_{w50} value as determined by the method of the analytical ultracentrifuge (in this regard cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Mächtle, pages 147 to 175).

The aqueous polymer dispersions with weight-average particle diameters D_{w}≦100 nm that are accessible in accordance with the process of the invention exhibit a surprisingly good blocking resistance and are therefore particularly suitable as binders for the coating of substrates, especially in transparent aqueous formulations for wood coatings.

Advantages frequently become apparent here, such as a reduced need for thickeners in order to set a particular viscosity, and also good and deep coloring when using color pigments, high penetration capacity of the formulation into the wood surface, or good “highlighting” of the wood grain. Moreover, the aqueous polymer dispersions of the invention exhibit improved filterability as compared with corresponding noninventive aqueous polymer dispersions.

The aqueous polymer dispersion typically has a solids content of 20% to 70% by weight, preferably 35% to 60% by weight.

The aqueous polymer dispersion obtained can be used, as it is or mixed with further, generally film-forming, polymers, as a binder composition in aqueous coating materials, such as paint or varnish mixtures.

Of course, the aqueous polymer dispersions of the invention that are obtainable by the process of the invention can also be used as a component in the production of adhesives, sealants, synthetic renders, paper coating slips, fiber webs, and coating materials for organic substrates, and also for modifying mineral binders.

The invention further provides a coating material in the form of an aqueous composition comprising
at least one polymer dispersion of the invention, as defined above,
optionally at least one (in)organic filler and/or at least one (in)organic pigment,
optionally at least one customary auxiliary, and
water.

The binder compositions of the invention are employed preferably in aqueous paints. These paints take the form, for example, of an unpigmented system (transparent varnish) or a pigmented system. The fraction of the pigments can be described by the pigment volume concentration (PVC). The PVC describes the ratio of the volume of pigments (V_{P}) and fillers (V_{F}) to the total volume, composed of the volumes of binder (V_{B}), pigments, and fillers in a dried coating film in percent: PVC=(V_{P}+V_{F})×100/(V_{P}+V_{F}+V_{B}). Paints can be classified on the basis of the PVC, for example, as follows:

| highly filled interior paint, wash resistant, white/matt | about 85 |
|---|---|
| interior paint, scrub resistant, white/matt | about 80 |
| semigloss paint, silk-matt | about 35 |
| semigloss paint, silk-gloss | about 25 |
| high-gloss paint | about 15-25 |
| exterior masonry paint, white | about 45-55 |
| clear varnish | <5 |

These dispersions are used preferably at a PVC<50, more preferably PVC<35, and even more preferably in systems with low filler content (PVC<23) and transparent varnishes (PVC<5).

Suitable fillers in transparent varnish systems are, for example, matting agents, which accordingly, as desired, significantly negatively affect the gloss. Matting agents are generally transparent and may be both organic and inorganic. Inorganic fillers based on silica are most suitable and are widely available commercially. Examples are the Syloid® products from W.R. Grace & Company, and their Acematt® products from Evonik GmbH. Organic matting agents are available, for example, from BYK-Chemie GmbH under the Ceraflour® and Ceramat® brand names, and from Deuteron GmbH under the Deuteron MK® brand name. Other suitable fillers for emulsion paints are aluminosilicates, such as feldspars, silicates, such as kaolin, talc, mica, magnesite, alkalin earth carbonates, such as calcium carbonate, in the form of calcite or chalk, for example, magnesium carbonate, dolomite, alkaline earth metal sulfates, such as calcium sulfate, silicon dioxide, etc. In paints, of course, finely divided fillers are preferred. The fillers can be used as individual components. In practice, however, it has been found particularly appropriate to have filler mixtures, examples being calcium carbonate/kaolin and calcium carbonate/talc. Glossy paints generally contain only small amounts of very fine fillers, or contain no fillers at all.

Finely divided fillers may also be used in order to increase the hiding power and/or to save on the use of white pigments. For adjusting the hiding power, the hue and the depth of color it is preferred to use blends of color pigments and fillers.

Examples of suitable pigments are inorganic white pigments such as titanium dioxide, preferably in the rutile form, barium sulfate, zinc oxide, zinc sulfide, basic lead carbonate, antimony trioxide, lithopones (zinc sulfide+barium sulfate) or colored pigments, examples being iron oxides, carbon black, graphite, zinc yellow, zinc green, ultramarine, manganese black, antimony black, manganese violet, Paris blue or Schweinfurt green. Besides the inorganic pigments, the emulsion paints of the invention may also comprise organic color pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone, and metal-complex pigments. Also suitable are synthetic white pigments with air inclusions to increase light scattering, such as the Ropaque® and AQACell® dispersions. Additionally suitable are the Luconyl® products from BASF SE, such as Lyconyl® yellow, Lyconyl® brown, and Luconyl® red, for example, especially the transparent varieties.

The coating material of the invention (aqueous paint) may optionally comprise additional film-forming polymers, pigment, and further auxiliaries, as well as the polymer dispersion.

The customary auxiliaries include wetting agents or dispersants, such as sodium, potassium or ammonium polyphosphates, alkali metal salts and ammonium salts of acrylic acid copolymers or maleic anhydride copolymers, polyphosphonates, such as sodium 1-hydroxyethane-1,1-diphosphonate, and also salts of naphthalenesulfonic acids, especially their sodium salts.

More important are the film-forming assistants, the thickeners, and defoamers. Suitable film-forming assistants are, for example, Texanol® from Eastman Chemicals, and the glycol ethers and esters, available commercially from BASF SE, for example, under the names Solvenon® and Lusolvan®, and from Dow under the tradename Dowanol®. The amount is preferably <10% by weight and more preferably <5% by weight, based on the total formulation. It is also possible to formulate entirely without solvents.

Other suitable auxiliaries are flow control agents, defoamers, biocides, and thickeners. Suitable thickeners are, for example, associative thickeners, such as polyurethane thickeners. The amount of the thickener is preferably less than 2.5% by weight, more preferably less than 1.5% by weight thickeners, based on paint solids content. Further formulating information for wood paints is described at length in ‘water-based acrylates for decorative coatings’ by the authors M. Schwartz and R. Baumstark, ISBN 3-87870-726-6.

The paints of the invention are produced in a known way by blending the components in mixing equipment customary for the purpose. It has been found appropriate to prepare an aqueous paste or dispersion from the pigments, water, and optionally the auxiliaries, and only then to mix the polymeric binder, i.e., in general, the aqueous dispersion of the polymer, with the pigment paste or pigment dispersion.

The paint of the invention can be applied to substrates in a customary way, as for example by spreading, spraying, dipping, rolling or knife coating.

The paints of the invention are notable for ease of handling and good processing properties. Their pollutant content is low. They have good performance properties, examples being high water resistance, effective wet adhesion, and good blocking resistance, good recoatability, and good flow on application. The equipment used is easily cleaned with water.

The invention will be illustrated by the nonlimiting examples which follow.

### EXAMPLES

### a) Preparation of the Aqueous Polymer Dispersions

In this text, the weight-average molecular weight Mw, unless indicated otherwise, is determined via size exclusion chromatography (SEC) using tetrahydrofuran+0.1% by weight trifluoroacetic acid as eluent, with a flow rate of 1 ml/min and a column temperature of 35° C. The sample is diluted to a concentration of 2 mg/ml in the eluent, and 100 μl of this diluted sample is injected, after the sample solution has been filtered through a 0.2 μm filter (Sartorius Minisart SRP 25) in order to remove any gel fraction. The columns used were three columns in combination, with an internal diameter of 7.5 mm, as follows: 5 cm preliminary column (PIgel 10μ Guard preliminary column), followed by two 30 cm separating columns (each PIgel 10μ Mixed B). Detection took place using a differential refractometer of type Agilent 1100, and a UV photometer of type Agilent 1100 VWD, PSS SLD7000-BI-MwA (UV/254 nm/Agilent). Calibration took place using narrow-range polystyrene standards from Polymer Laboratories, with molecular weights of M=580 to M=7,500,000, and also hexylbenzene (M=162). The values outside of the elution range were extrapolated.

The filtration prior to molecular weight determination removes any gel fraction in the polymer, and so the reported values refer to the sol fraction.

The insoluble fraction of polymer can be determined by four-hour extraction with tetrahydrofuran in a Soxhlet apparatus and weighing of the residue which remains after the extraction residue has been dried to constant weight.

The solids content (SC) was determined generally by drying a defined amount of the aqueous polymer dispersion (approximately 1 g) to constant weight on an aluminum crucible having an internal diameter of approximately 5 cm in a drying cabinet at 140° C. Two separate measurements were carried out. The values reported in the examples represent the average of the two results in each case.

The minimum film-forming temperature (MFFT) was determined in accordance with Ullmanns Enzyklopädie der technischen Chemie, 4th edn., vol. 19, Verlag Chemie, Weinheim (1980), p. 17. The instrument used was a film-forming bench (a metal plate to which a temperature gradient is applied). Filming took place at a wet film thickness of 1 mm. The minimum film-forming temperature reported is the temperature at which the film begins to develop cracks.

### Comparative Example 1 (CE1)

A polymerization vessel equipped with metering devices and temperature regulation was charged at 20 to 25° C. (room temperature) under a nitrogen atmosphere with

| | |
|---|---|
| 200.8 g | of deionized water and |
| 35.0 g | of a 15% strength by weight aqueous solution |
| | of sodium lauryl sulfate, |

and this initial charge was heated to 87° C. with stirring. When this temperature had been reached, 29.8 g of feed 1 and subsequently, with the temperature maintained, 2.0 g of feed 3 were added, and polymerization took place for 5 minutes. Thereafter, beginning simultaneously, the remainder of feed 1 was metered in continuously over the course of 120 minutes, and, in parallel with this, the remainder of feed 3 was metered in continuously over the course of 165 minutes, at constant flow rates. After the end of feed 1, feed 2 was commenced and was metered in continuously over the course of 45 minutes at a constant flow rate.

### Feed 1 (Homogeneous Mixture of):

| | | |
|---|---|---|
| 329.1 | g | of deionized water |
| 23.3 | g | of a 15% strength by weight aqueous solution |
| | | of sodium lauryl sulfate |
| 5.7 | g | of a 50% strength by weight aqueous solution |
| | | of acrylamide |
| 5.1 | g | of acrylic acid |
| 27.0 | g | of a 25% strength by weight solution |
| | | of ureido methacrylate in methyl methacrylate ^{a)} |
| 199.2 | g | of methyl methacrylate and |
| 285.5 | g | of 2-ethylhexyl acrylate |

### Feed 2 (Homogeneous Mixture of):

| | | |
|---|---|---|
| 174.4 | g | of deionized water |
| 8.9 | g | of a 15% strength by weight aqueous solution |
| | | of sodium lauryl sulfate |
| 5.1 | g | of acrylic acid |
| 27.0 | g | of a 25% strength by weight solution |
| | | of ureido methacrylate in methyl methacrylate ^{a)} and |
| 148.2 | g | of methyl methacrylate |

### Feed 3 (Homogeneous Solution of):

| | |
|---|---|
| 13.0 g | of deionized water and |
| 1.0 g | of sodium peroxodisulfate |

After the end of feeds 2 and 3, the polymerization mixture was reacted for 30 minutes more at 87° C. Following this, beginning simultaneously but via separate feed lines, 22.4 g of a 5% strength by weight aqueous hydrogen peroxide solution, and a solution of 1.0 g of ascorbic acid and 26.5 g of deionized water, were metered in to the polymerization mixture continuously over the course of 60 minutes at constant flow rates.

The aqueous polymer dispersion obtained was subsequently cooled to room temperature, neutralized with 5.9 g of a 25% strength by weight aqueous ammonia solution, and filtered through a 125 μm filter.

The resulting 1544 g of the aqueous polymer dispersion had a solids content of 45.2% by weight. The MFFT was 13° C. Diluted with deionized water, the aqueous polymer dispersion has a weight-average particle diameter of 82 nm.

^{a)} Plex® 6844-O from Röhm GmbH.

### Example 1 (E1)

A polymerization vessel equipped with metering devices and temperature regulation was charged at 20 to 25° C. (room temperature) under a nitrogen atmosphere with

| | |
|---|---|
| 567.3 g | of deionized water and |
| 8.3 g | of a 15% strength by weight aqueous solution |
| | of sodium lauryl sulfate, |

and this initial charge was heated to 80° C. with stirring. When this temperature had been reached, all of feed 1 was added, and the mixture was stirred for 2 minutes. Thereafter feed 2 was commenced and was metered in over the course of 32 minutes. After the end of feed 2, polymerization was continued for 10 minutes, then feed 3 was added over 10 minutes. The weight-average molecular weight of the polymer, from a sample taken at this point in time, was 23.1 kDa. Subsequently feed 4 was commenced and was metered in continuously over the course of 104 minutes, at a constant flow rate. 52 minutes after the start of feed 4, 10 g of a 3% strength by weight ammonia solution were added.

### Feed 1 (Homogeneous Solution of):

| | |
|---|---|
| 26.6 g | of deionized water and |
| 2.0 g | of sodium peroxodisulfate |

### Feed 2 (Homogeneous Mixture of):

| | | |
|---|---|---|
| 8.1 | g | of methacrylic acid |
| 1.9 | g | of acrylic acid |
| 12.5 | g | of styrene |
| 80.0 | g | of methyl methacrylate |
| 12.5 | g | of n-butyl acrylate |
| 10.0 | g | of diacetoneacrylamide and |
| 2.0 | g | of 2-ethylhexyl thioglycolate |

### Feed 3 (Homogeneous Mixture of):

| | |
|---|---|
| 7.0 g | of deionized water and |
| 1.0 g | of a 25% strength by weight ammonia solution |

### Feed 4 (Homogeneous Mixture of):

| | |
|---|---|
| 260.0 g | of n-butyl acrylate and |
| 115.0 g | of methyl methacrylate |

After the end of feed 4, the polymerization mixture was reacted for 90 minutes more at 80° C. Then 18.2 g of a 5% strength by weight ammonia solution were added over 5 minutes.

Subsequently the aqueous polymer dispersion obtained was cooled to room temperature. At a temperature below 40° C., 41.7 g of a 12% strength by weight aqueous solution of adipic dihydrazide were added. Finally, the dispersion was filtered through a 125 μm filter.

The resulting 1184.1 g of the aqueous polymer dispersion had a solids content of 43.2% by weight. The MFFT was ≦0° C. Diluted with deionized water, the aqueous polymer dispersion has a weight-average particle diameter of 70 nm.

### Example 2 (E2)

A polymerization vessel equipped with metering devices and temperature regulation was charged at 20 to 25° C. (room temperature) under a nitrogen atmosphere with

| | |
|---|---|
| 567.2 g | of deionized water and |
| 10.0 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 38 minutes. After the end of feed 2, polymerization was continued for 10 minutes, then feed 3 was added over 10 minutes. The weight-average molecular weight of the polymer, from a sample taken at this point in time, was 23.8 kDa. Subsequently feed 4 was commenced and was metered in continuously over the course of 96 minutes, at a constant flow rate. 48 minutes after the start of feed 4, 12 g of a 3% strength by weight ammonia solution were added.

### Feed 1 (Homogeneous Solution of):

| | |
|---|---|
| 26.6 g | of deionized water and |
| 2.0 g | of sodium peroxodisulfate |

### Feed 2 (Homogeneous Mixture of):

| | | |
|---|---|---|
| 9.8 | g | of methacrylic acid |
| 2.3 | g | of acrylic acid |
| 15.0 | g | of styrene |
| 96.0 | g | of methyl methacrylate |
| 15.0 | g | of n-butyl acrylate |
| 12.0 | g | of diacetoneacrylamide and |
| 2.4 | g | of 2-ethylhexyl thioglycolate |

### Feed 3 (Homogeneous Mixture of):

| | |
|---|---|
| 8.4 g | of deionized water and |
| 1.1 g | of a 25% strength by weight ammonia solution |

### Feed 4 (Homogeneous Mixture of):

| | |
|---|---|
| 242.0 g | of n-butyl acrylate and |
| 108.0 g | of methyl methacrylate |

After the end of feed 4, the polymerization mixture was reacted for 90 minutes more at 80° C. Then 21.8 g of a 5% strength by weight ammonia solution were added over 5 minutes.

Subsequently the aqueous polymer dispersion obtained was cooled to room temperature. At a temperature below 40° C., 50.0 g of a 12% strength by weight aqueous solution of adipic dihydrazide were added. Finally, the dispersion was filtered through a 125 μm filter.

The resulting 1199.1 g of the aqueous polymer dispersion had a solids content of 42.6% by weight. The MFFT was ≦0° C. Diluted with deionized water, the aqueous polymer dispersion has a weight-average particle diameter of 66 nm.

### Example 3 (E3)

A polymerization vessel equipped with metering devices and temperature regulation was charged at 20 to 25° C. (room temperature) under a nitrogen atmosphere with

| | |
|---|---|
| 566.4 g | of deionized water and |
| 11.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 45 minutes. After the end of feed 2, polymerization was continued for 10 minutes, then feed 3 was added over 10 minutes. The weight-average molecular weight of the polymer, from a sample taken at this point in time, was 22.1 kDa. Subsequently feed 4 was commenced and was metered in continuously over the course of 90 minutes, at a constant flow rate. 45 minutes after the start of feed 4, 13.9 g of a 3% strength by weight ammonia solution were added.

### Feed 1 (Homogeneous Solution of):

| | |
|---|---|
| 26.6 g | of deionized water and |
| 2.0 g | of sodium peroxodisulfate |

### Feed 2 (Homogeneous Mixture of):

| | | |
|---|---|---|
| 11.4 | g | of methacrylic acid |
| 2.6 | g | of acrylic acid |
| 17.5 | g | of styrene |
| 112.0 | g | of methyl methacrylate |
| 17.5 | g | of n-butyl acrylate |
| 14.0 | g | of diacetoneacrylamide and |
| 2.8 | g | of 2-ethylhexyl thioglycolate |

### Feed 3 (Homogeneous Mixture of):

| | |
|---|---|
| 9.8 g | of deionized water and |
| 1.3 g | of a 25% strength by weight ammonia solution |

### Feed 4 (Homogeneous Mixture of):

| | |
|---|---|
| 225.0 g | of n-butyl acrylate and |
| 100.0 g | of methyl methacrylate |

After the end of feed 4, the polymerization mixture was reacted for 90 minutes more at 80° C. Then 25.42 g of a 5% strength by weight ammonia solution were added over 5 minutes.

Subsequently the aqueous polymer dispersion obtained was cooled to room temperature. At a temperature below 40° C., 58.3 g of a 12% strength by weight aqueous solution of adipic dihydrazide were added. Finally, the dispersion was filtered through a 125 μm filter.

The resulting 1215.4 g of the aqueous polymer dispersion had a solids content of 41.8% by weight. The MFFT was ≦1° C. Diluted with deionized water, the aqueous polymer dispersion has a weight-average particle diameter of 62 nm.

### Example 4 (E4)

A polymerization vessel equipped with metering devices and temperature regulation was charged at 20 to 25° C. (room temperature) under a nitrogen atmosphere with

| | |
|---|---|
| 1198.1 g | of deionized water and |
| 26.0 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added over 10 minutes. The weight-average molecular weight of the polymer, from a sample taken at this point in time, was 23.0 kDa. Subsequently feed 4 was commenced and was metered in continuously over the course of 90 minutes, at a constant flow rate. 45 minutes after the start of feed 4, 31.2 g of a 3% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 164.7 | g | of deionized water |
| 8.7 | g | of a 15% strength by weight aqueous solution |
| | | of sodium lauryl sulfate |
| 25.4 | g | of methacrylic acid |
| 5.9 | g | of acrylic acid |
| 39.0 | g | of styrene |
| 249.6 | g | of methyl methacrylate |
| 39.0 | g | of n-butyl acrylate |
| 156.0 | g | of a 20% strength aqueous solution |
| | | of diacetoneacrylamide and |
| 6.2 | g | of 2-ethylhexyl thioglycolate |

### Feed 3 (Homogeneous Mixture of):

| | |
|---|---|
| 21.7 g | of deionized water and |
| 3.0 g | of a 25% strength by weight ammonia solution |

### Feed 4 (Homogeneous Mixture of):

| | |
|---|---|
| 629.2 g | of n-butyl acrylate and |
| 280.8 g | of methyl methacrylate |

After the end of feed 4, the polymerization mixture was reacted for 90 minutes more at 80° C. Then 56.7 g of a 5% strength by weight ammonia solution were added over 5 minutes.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The resulting 3145.3 g of the aqueous polymer dispersion had a solids content of 42.8% by weight. The MFFT was 1° C. Diluted with deionized water, the aqueous polymer dispersion has a weight-average particle diameter of 60 nm.

### Example 5 (E5)

A polymerization vessel equipped with metering devices and temperature regulation was charged at 20 to 25° C. (room temperature) under a nitrogen atmosphere with

| | |
|---|---|
| 840.5 g | of deionized water and |
| 34.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added over 10 minutes. The weight-average molecular weight of the sample taken at this point in time, was 22.0 kDa. Subsequently feed 4 was commenced and was metered in continuously over the course of 90 minutes, at a constant flow rate. 45 minutes after the start of feed 4, 31.2 g of a 3% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 130.0 | g | of deionized water |
| 8.7 | g | of a 15% strength by weight aqueous solution |
| | | of sodium lauryl sulfate |
| 25.4 | g | of methacrylic acid |
| 5.9 | g | of acrylic acid |
| 39.0 | g | of styrene |
| 249.6 | g | of methyl methacrylate |
| 39.0 | g | of n-butyl acrylate |
| 156.0 | g | of a 20% strength aqueous solution |
| | | of diacetoneacrylamide and |
| 6.2 | g | of 2-ethylhexyl thioglycolate |

### Feed 3 (Homogeneous Mixture of):

| | |
|---|---|
| 21.7 g | of deionized water and |
| 3.0 g | of a 25% strength by weight ammonia solution |

### Feed 4 (Homogeneous Mixture of):

| | |
|---|---|
| 451.5 g | of deionized water |
| 17.3 g | of a 15% strength by weight aqueous solution |
| | of sodium lauryl sulfate |
| 629.2 g | of n-butyl acrylate and |
| 280.8 g | of methyl methacrylate |

After the end of feed 4, the polymerization mixture was reacted for 90 minutes more at 80° C. Then 56.7 g of a 5% strength by weight ammonia solution were added over 5 minutes.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The resulting 3230.4 g of the aqueous polymer dispersion had a solids content of 41.7% by weight. The MFFT was ≦1° C. Diluted with deionized water, the aqueous polymer dispersion has a weight-average particle diameter of 64 nm.

### Comparative Example 2 (CE2)

A polymerization vessel equipped with metering devices and temperature regulation was charged at 20 to 25° C. (room temperature) under a nitrogen atmosphere with

| | |
|---|---|
| 1474.8 g | of deionized water and |
| 26.0 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 38 minutes. After the end of feed 2, polymerization was continued for 10 minutes, then feed 3 was added over 10 minutes. The weight-average molecular weight of the polymer, from a sample taken at this point in time, was 23.0 kDa. Subsequently feed 4 was commenced and was metered in continuously over the course of 96 minutes, at a constant flow rate. 48 minutes after the start of feed 4, 31.2 g of a 3% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 25.4 | g | of methacrylic acid |
| 5.7 | g | of acrylic acid |
| 39.0 | g | of styrene |
| 249.6 | g | of methyl methacrylate |
| 39.0 | g | of n-butyl acrylate |
| 31.2 | g | of diacetoneacrylamide and |
| 6.2 | g | of 2-ethylhexyl thioglycolate |

### Feed 3 (Homogeneous Mixture of):

| | |
|---|---|
| 21.7 g | of deionized water and |
| 3.0 g | of a 25% strength by weight ammonia solution |

### Feed 4 (Homogeneous Mixture of):

| | |
|---|---|
| 629.2 g | of n-butyl acrylate and |
| 280.8 g | of methyl methacrylate |

After the end of feed 4, the polymerization mixture was reacted for 90 minutes more at 80° C. Then 56.7 g of a 5% strength by weight ammonia solution were added over 5 minutes.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The resulting 3123.8 g of the aqueous polymer dispersion had a solids content of 41.3% by weight. The MFFT was ≦1° C. Diluted with deionized water, the aqueous polymer dispersion has a weight-average particle diameter of 65 nm.

### Example 6 (E6)

A polymerization vessel equipped with metering devices and temperature regulation was charged at 20 to 25° C. (room temperature) under a nitrogen atmosphere with

| | |
|---|---|
| 884.6 g | of deionized water and |
| 15.6 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 38 minutes. After the end of feed 2, polymerization was continued for 10 minutes, then feed 3 was added over 10 minutes. The weight-average molecular weight of a sample taken at this point in time was 22.5 kDa. Subsequently feed 4 was commenced and was metered in continuously over the course of 96 minutes, at a constant flow rate. 45 minutes after the start of feed 4, 18.7 g of a 3% strength by weight ammonia solution were added.

### Feed 1 (Homogeneous Solution of):

| | |
|---|---|
| 41.5 g | of deionized water and |
| 3.1 g | of sodium peroxodisulfate |

### Feed 2 (Homogeneous Mixture of):

| | | |
|---|---|---|
| 15.2 | g | of methacrylic acid |
| 3.5 | g | of acrylic acid |
| 23.4 | g | of styrene |
| 140.4 | g | of methyl methacrylate |
| 23.4 | g | of n-butyl acrylate |
| 9.4 | g | of a 25% strength by weight solution |
| | | of ureidomethacrylate in methyl methacrylate^{a)} |
| 18.7 | g | of diacetoneacrylamide and |
| 3.7 | g | of 2-ethylhexyl thioglycolate |

### Feed 3 (Homogeneous Mixture of):

| | |
|---|---|
| 13.0 g | of deionized water and |
| 1.8 g | of a 25% strength by weight ammonia solution |

### Feed 4 (Homogeneous Mixture of):

| | |
|---|---|
| 377.5 g | of n-butyl acrylate and |
| 168.5 g | of methyl methacrylate |

After the end of feed 4, the polymerization mixture was reacted for 90 minutes more at 80° C. Then 34.0 g of a 5% strength by weight ammonia solution were added over 5 minutes.

Subsequently the aqueous polymer dispersion obtained was cooled to room temperature. At a temperature below 40° C., 78 g of a 12% strength by weight aqueous solution of adipic dihydrazide were added. Finally, the dispersion was filtered through a 125 μm filter.

The resulting 1874 g of the aqueous polymer dispersion had a solids content of 41.6% by weight. The MFFT was ≦1° C. Diluted with deionized water, the aqueous polymer dispersion has a weight-average particle diameter of 64 nm.

^{a}) Plex® 6844-O from Röhm GmbH.

### Example 7 (E7)

A polymerization vessel equipped with metering devices and temperature regulation was charged at 20 to 25° C. (room temperature) under a nitrogen atmosphere with

| | |
|---|---|
| 884.6 g | of deionized water and |
| 15.6 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 38 minutes. After the end of feed 2, polymerization was continued for 10 minutes, then feed 3 was added over 10 minutes. The weight-average molecular weight of the polymer, from a sample taken at this point in time, was 33.6 kDa. Subsequently feed 4 was commenced and was metered in continuously over the course of 96 minutes, at a constant flow rate. 45 minutes after the start of feed 4, 18.7 g of a 3% strength by weight ammonia solution were added.

### Feed 1 (Homogeneous Solution of):

| | |
|---|---|
| 41.5 g | of deionized water and |
| 3.1 g | of sodium peroxodisulfate |

### Feed 2 (Homogeneous Mixture of):

| | | |
|---|---|---|
| 15.2 | g | of methacrylic acid |
| 3.5 | g | of acrylic acid |
| 23.4 | g | of styrene |
| 118.6 | g | of methyl methacrylate |
| 23.4 | g | of n-butyl acrylate |
| 31.2 | g | of a 25% strength by weight solution |
| | | of ureidomethacrylate in methyl methacrylate^{a)} |
| 18.7 | g | of diacetoneacrylamide and |
| 3.7 | g | of 2-ethylhexyl thioglycolate |

### Feed 3 (Homogeneous Mixture of):

| | |
|---|---|
| 13.0 g | of deionized water and |
| 1.8 g | of a 25% strength by weight ammonia solution |

### Feed 4 (Homogeneous Mixture of):

| | |
|---|---|
| 377.5 g | of n-butyl acrylate and |
| 168.5 g | of methyl methacrylate |

After the end of feed 4, the polymerization mixture was reacted for 90 minutes more at 80° C. Then 34.0 g of a 5% strength by weight ammonia solution were added over 5 minutes.

Subsequently the aqueous polymer dispersion obtained was cooled to room temperature. At a temperature below 40° C., 78 g of a 12% strength by weight aqueous solution of adipic dihydrazide were added. Finally, the dispersion was filtered through a 125 μm filter.

The resulting 1874 g of the aqueous polymer dispersion had a solids content of 41.5% by weight. The MFFT was ≦1° C. Diluted with deionized water, the aqueous polymer dispersion has a weight-average particle diameter of 87 nm.

^{a}) Plex® 6844-O from Röhm GmbH.

### Comparative Example 3 (CE3)

A polymerization vessel equipped with metering devices and temperature regulation was charged at 20 to 25° C. (room temperature) under a nitrogen atmosphere with

| | |
|---|---|
| 323.1 g | of deionized water and |
| 13.3 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added, the mixture was stirred for 10 minutes, and subsequently feed 4 was commenced and was metered in continuously over the course of 90 minutes, at a constant flow rate. 45 minutes after the start of feed 4, 1.1 g of a 25% strength by weight ammonia solution were added.

### Feed 1 (Homogeneous Solution of):

| | |
|---|---|
| 26.6 g | of deionized water and |
| 2.0 g | of sodium peroxodisulfate |

### Feed 2 (Homogeneous Mixture of):

| | | |
|---|---|---|
| 47.8 | g | of deionized water |
| 3.3 | g | of a 15% strength by weight aqueous solution |
| | | of sodium lauryl sulfate |
| 9.8 | g | of methacrylic acid |
| 4.5 | g | of a 50% strength by weight aqueous solution |
| | | of acrylamide |
| 15.0 | g | of styrene |
| 92.0 | g | of methyl methacrylate |
| 15.0 | g | of n-butyl acrylate |
| 60.0 | g | of a 20% strength by weight aqueous solution |
| | | of diacetoneacrylamide and |
| 2.4 | g | of 2-ethylhexyl thioglycolate |

### Feed 3:

| | |
|---|---|
| 0.9 g | of a 25% strength by weight ammonia solution |

### Feed 4 (Homogeneous Mixture of):

| | |
|---|---|
| 147.3 g | of deionized water |
| 6.7 g | of a 15% strength by weight aqueous solution |
| | of sodium lauryl sulfate |
| 242.0 g | of n-butyl acrylate and |
| 108.0 g | of methyl methacrylate |

After the end of feed 4, the polymerization mixture was reacted for 90 minutes more at 80° C. Then 3.4 g of a 25% strength by weight ammonia solution were added.

Subsequently the aqueous polymer dispersion obtained was cooled to room temperature. At a temperature below 40° C., 50 g of a 12% strength by weight aqueous solution of adipic dihydrazide were added. Finally, the dispersion was filtered through a 125 μm filter.

The weight-average molecular weight of the polymer of a sample taken before the start of feed 4 was 22.5 kDa.

The resulting 1174 g of the aqueous polymer dispersion had a solids content of 42.5% by weight. The MFFT was ≦1° C. Diluted with deionized water, the aqueous polymer dispersion has a weight-average particle diameter of 75 nm.

### Example 8 (E8)

A polymerization vessel equipped with metering devices and temperature regulation was charged at 20 to 25° C. (room temperature) under a nitrogen atmosphere with

| | |
|---|---|
| 840.2 g | of deionized water and |
| 34.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added, the mixture was stirred for 10 minutes, and subsequently feed 4 was commenced and was metered in continuously over the course of 90 minutes, at a constant flow rate. 45 minutes after the start of feed 4, 2.6 g of a 25% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 109.4 | g | of deionized water |
| 8.7 | g | of a 15% strength by weight aqueous solution |
| | | of sodium lauryl sulfate |
| 22.8 | g | of methacrylic acid |
| 17.3 | g | of a 15% strength by weight aqueous solution |
| | | of methacrylamide |
| 11.7 | g | of a 50% strength by weight aqueous solution |
| | | of acrylamide |
| 39.0 | g | of styrene |
| 249.6 | g | of methyl methacrylate |
| 39.0 | g | of n-butyl acrylate |
| 156.0 | g | of a 20% strength by weight aqueous solution |
| | | of diacetoneacrylamide and |
| 6.2 | g | of 2-ethylhexyl thioglycolate |

### Feed 3:

| | |
|---|---|
| 2.1 g | of a 25% strength by weight ammonia solution |

### Feed 4 (Homogeneous Mixture of):

| | |
|---|---|
| 382.9 g | of deionized water |
| 17.3 g | of a 15% strength by weight aqueous solution |
| | of sodium lauryl sulfate |
| 629.2 g | of n-butyl acrylate and |
| 280.8 g | of methyl methacrylate |

After the end of feed 4, the polymerization mixture was reacted for 90 minutes more at 80° C. Then 8 g of a 25% strength by weight ammonia solution were added.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The weight-average molecular weight of the polymer of a sample taken before the start of feed 4 was 23.2 kDa.

The resulting 3060 g of the aqueous polymer dispersion had a solids content of 41.9% by weight. The MFFT was ≦1° C. Diluted with deionized water, the aqueous polymer dispersion has a weight-average particle diameter of 71 nm.

### Example 9 (E9)

A polymerization vessel equipped with metering devices and temperature regulation was charged at 20 to 25° C. (room temperature) under a nitrogen atmosphere with

| | |
|---|---|
| 840.2 g | of deionized water and |
| 34.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added, the mixture was stirred for 10 minutes, and subsequently feed 4 was commenced and was metered in continuously over the course of 90 minutes, at a constant flow rate. 45 minutes after the start of feed 4, 2.3 g of a 25% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 91.0 | g | of deionized water |
| 8.7 | g | of a 15% strength by weight aqueous solution |
| | | of sodium lauryl sulfate |
| 19.5 | g | of methacrylic acid |
| 39.0 | g | of a 15% strength by weight aqueous solution |
| | | of methacrylamide |
| 11.7 | g | of a 50% strength by weight aqueous solution |
| | | of acrylamide |
| 39.0 | g | of styrene |
| 249.6 | g | of methyl methacrylate |
| 39.0 | g | of n-butyl acrylate |
| 156.0 | g | of a 20% strength by weight aqueous solution |
| | | of diacetoneacrylamide and |
| 6.2 | g | of 2-ethylhexyl thioglycolate |

### Feed 3:

| | |
|---|---|
| 1.8 g | of a 25% strength by weight ammonia solution |

### Feed 4 (Homogeneous Mixture of):

| | |
|---|---|
| 382.9 g | of deionized water |
| 17.3 g | of a 15% strength by weight aqueous solution |
| | of sodium lauryl sulfate |
| 629.2 g | of n-butyl acrylate and |
| 280.8 g | of methyl methacrylate |

After the end of feed 4, the polymerization mixture was reacted for 90 minutes more at 80° C. Then 6.8 g of a 25% strength by weight ammonia solution were added.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The weight-average molecular weight of the polymer of a sample taken before the start of feed 4 was 22.8 kDa.

The resulting 3059 g of the aqueous polymer dispersion had a solids content of 42.2% by weight. The MFFT was ≦1° C. Diluted with deionized water, the aqueous polymer dispersion has a weight-average particle diameter of 71 nm.

### Example 10 (E10)

A polymerization vessel equipped with metering devices and temperature regulation was charged at 20 to 25° C. (room temperature) under a nitrogen atmosphere with

| | |
|---|---|
| 840.2 g | of deionized water and |
| 34.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added, the mixture was stirred for 10 minutes, and subsequently feed 4 was commenced and was metered in continuously over the course of 90 minutes, at a constant flow rate. 45 minutes after the start of feed 4, 1.9 g of a 25% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 72.6 | g | of deionized water |
| 8.7 | g | of a 15% strength by weight aqueous solution |
| | | of sodium lauryl sulfate |
| 16.3 | g | of methacrylic acid |
| 60.7 | g | of a 15% strength by weight aqueous solution |
| | | of methacrylamide |
| 11.7 | g | of a 50% strength by weight aqueous solution |
| | | of acrylamide |
| 39.0 | g | of styrene |
| 249.6 | g | of methyl methacrylate |
| 39.0 | g | of n-butyl acrylate |
| 156.0 | g | of a 20% strength by weight aqueous solution |
| | | of diacetoneacrylamide and |
| 6.2 | g | of 2-ethylhexyl thioglycolate |

### Feed 3:

| | |
|---|---|
| 1.5 g | of a 25% strength by weight ammonia solution |

### Feed 4 (Homogeneous Mixture of):

| | |
|---|---|
| 382.9 g | of deionized water |
| 17.3 g | of a 15% strength by weight aqueous solution |
| | of sodium lauryl sulfate |
| 629.2 g | of n-butyl acrylate and |
| 280.8 g | of methyl methacrylate |

After the end of feed 4, the polymerization mixture was reacted for 90 minutes more at 80° C. Then 5.7 g of a 25% strength by weight ammonia solution were added.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The weight-average molecular weight of the polymer of a sample taken before the start of feed 4 was 22.9 kDa.

The resulting 3058 g of the aqueous polymer dispersion had a solids content of 42.1% by weight. The MFFT was 1° C. Diluted with deionized water, the aqueous polymer dispersion has a weight-average particle diameter of 71 nm.

### Example 11 (E11)

A polymerization vessel equipped with metering devices and temperature regulation was charged at 20 to 25° C. (room temperature) under a nitrogen atmosphere with

| | |
|---|---|
| 840.2 g | of deionized water and |
| 34.7 g | of a 15% strength by weight aqueous solution |
| | of sodium lauryl sulfate |

and this initial charge was heated to 80° C. with stirring. When this temperature had been reached, all of feed 1 was added, and the mixture was stirred for 2 minutes. Thereafter feed 2 was commenced and was metered in over the course of 40 minutes. After the end of feed 2, polymerization was continued for 10 minutes, then feed 3 was added, the mixture was stirred for 10 minutes, and subsequently feed 4 was commenced and was metered in continuously over the course of 90 minutes, at a constant flow rate. 45 minutes after the start of feed 4, 1.5 of a 25% strength by weight ammonia solution were added.

### Feed 1 (Homogeneous Solution of):

| | |
|---|---|
| 69.1 g | of deionized water and |
| 5.2 g | of sodium peroxodisulfate |

### Feed 2 (Homogeneous Mixture of):

| | | |
|---|---|---|
| 54.2 | g | of deionized water |
| 8.7 | g | of a 15% strength by weight aqueous solution |
| | | of sodium lauryl sulfate |
| 13.0 | g | of methacrylic acid |
| 82.3 | g | of a 15% strength by weight aqueous solution |
| | | of methacrylamide |
| 11.7 | g | of a 50% strength by weight aqueous solution |
| | | of acrylamide |
| 39.0 | g | of styrene |
| 249.6 | g | of methyl methacrylate |
| 39.0 | g | of n-butyl acrylate |
| 156.0 | g | of a 20% strength by weight aqueous solution |
| | | of diacetoneacrylamid and |
| 6.2 | g | of 2-ethylhexyl thioglycolate |

### Feed 3:

| | |
|---|---|
| 1.2 g | of a 25% strength by weight ammonia solution |

### Feed 4 (Homogeneous Mixture of):

| | |
|---|---|
| 382.9 g | of deionized water |
| 17.3 g | of a 15% strength by weight aqueous solution |
| | of sodium lauryl sulfate |
| 629.2 g | of n-butyl acrylate and |
| 280.8 g | of methyl methacrylate |

After the end of feed 4, the polymerization mixture was reacted for 90 minutes more at 80° C. Then 4.6 g of a 25% strength by weight ammonia solution were added.

Subsequently the aqueous polymer dispersion obtained was cooled to room temperature. At a temperature below 40° C., 130 g of a 12% strength by weight aqueous solution of adipic dihydrazide were added. Finally, the dispersion was filtered through a 125 μm filter.

The weight-average molecular weight of the polymer of a sample taken before the start of feed 4 was 23.3 kDa.

The resulting 3056.8 g of the aqueous polymer dispersion had a solids content of 42.1% by weight. The MFFT was ≦1° C. Diluted with deionized water, the aqueous polymer dispersion has a weight-average particle diameter of 75 nm.

### b) Performance Investigations

Performance investigations were carried out on a clear varnish formulation according to the formula indicated below:

| | | | |
|---|---|---|---|
| DI water | | | 80 |
| Byk ® 348 | Wetting agent from BYK-Chemie GmbH | | 2 |
| Tego Airex ® 901 W | Defoamer from Evonik GmbH | | 4 |
| Solvenon ® DPM | Film-forming assistant from BASF SE | Solvent and Tinuvin | 20 |
| Butyl glycol | Film-forming assistant | were premixed | 20 |
| Tinuvin ® 1130 | Light stabilizer from BASF SE | | 10 |
| Tego Glide ® 482 | Flow control additive from Evonik GmbH | | 3 |
| Coapur ® 830 W | Thickener from Coatex SAS | | 4 |
| Coapur ® XS 73 | Thickener from Coatex SAS | | 4 |
| Ammonia | Neutralizing agent (25% strength) | | 2 |
| SYLOID W ® 500 | Filler from W. R. Grace & Company | | 15 |
| Dispersion | | 40.6% | 831 |
| Tego Foamex ® 810 | Defoamer from Evonik GmbH | | 5 |
| total | | | 1000 |

The components were added in succession and mixed homogeneous after each step. The following tests were carried out:

### Storage Stability Test

The formulation was subjected to a storage test. Closed 100 ml sample vials were stored at 50° C. for 14 days and tested for increase in viscosity. The Krebs viscosity of the coating was determined at 23° C., using a Brookfield KU 1 viscometer (in accordance with ASTM D562), before and after 14 days of storage at 50° C. In the event of viscosity differences of more than 20 KU units, coatings are referred to as not storage-stable.

### Wet Adhesion Tests, Wood Stain on Pine

The stain under test (300 μm wet) was applied using the Erichsen film applicator to the pine strip. After a drying time of 7 days at RT, the test area was prepared using the cross-cut tester and cutter (45° to the grain of the wood, 7 cuts, 2 mm cut spacing). The cross-cutting was carried out in accordance with EN ISO 2409, with a distance of 2 mm between the cuts. Then about 2.5 ml of DI water were pipetted into the Petri dish, which was centered on the lattice of cuts, made beforehand, for a period of 2 hours (strip was placed on the Petri dish and then rotated by 180°). The Petri dish was removed and the remaining DI water was taken up with a cloth. After a further 10 minutes, a strip of Tesa adhesive tape with a length of approximately 50 mm was adhered (45° to all of the cuts and in the direction of the wood grain) and smoothed out, and then peeled from the specimen at a uniform speed.

### Evaluation: Assessment of the Damage Patterns

0=No square damaged, cut edges smooth
1=No delaminations, <5% of the area
2=Delaminations of the edge and at cuts, 5-15%
3=Delaminations at corners, parts of the squares, 15-35%
4=Coating can be peeled off in long strips, whole squares delaminated, 35-65%
5=Delaminated area>65%

### Pendulum Hardness of Stain on Glass

The stain under test was knife-coated using an Erichsen film applicator (300 μm wet) to a glass plate measuring 38×7 cm. After 3 days of drying at room temperature, three pendulum measurements were taken at three points on the glass plate. Measurement took place by the method of König (DIN EN ISO 1522).

TABLE 1

| | SC | Amount of | MFFT | D_{w} | Pendulum |
|---|---|---|---|---|---|
| Sample | (%) | emulsifier (pphm) | (° C.) | (nm) | hardness (s) |
| CE 1 | 45 | 1.45 | 13 | 82 | 24 |
| E 1 | 42 | 0.25 | ≦0 | 70 | 27 |
| E 2 | 41 | 0.30 | ≦0 | 66 | 35 |
| E 3 | 41 | 0.35 | ≦1 | 62 | 45 |
| E 4 | 42.8 | 0.40 | ≦1 | 59 | 36 |
| E 5 | 41.7 | 0.70 | ≦1 | 64 | 34 |

The data from table 1 show that the inventive dispersions with little emulsifier are nevertheless finely divided and have a low film-forming temperature. At the same time they exhibit a high pendulum hardness.

TABLE 2

| | Adhesion monomer ¹⁾ | Wet adhesion |
|---|---|---|
| Sample | (% by weight) | (school grade) |
| CE 2 | 0 | 3 |
| E 6 | 0.3 | 1 |
| E 7 | 1 | 0 |

¹⁾ Based on 100 parts by weight of the total monomers for polymerization in first and second stages and optionally further stages.

The data from table 2 show very clearly the effect of an additional adhesion monomer on the wet adhesion of the coating of the corresponding polymer dispersion.

TABLE 3

| | Methacrylic | Meth- | pH of | KU | KU |
|---|---|---|---|---|---|
| Sam- | acid ¹⁾ | acrylamide ¹⁾ | wood | instanta- | after 14 d |
| ple | (% by wt.) | (% by wt.) | stain | neous | 50° C. |
| CE 3 | 1.95 | 0 | 8.3 | 68 | not |
| | | | | | measurable |
| E 8 | 1.75 | 0.20 | 8.9 | 91 | 123 |
| E 9 | 1.50 | 0.45 | 9.1 | 86 | 113 |
| E 10 | 1.25 | 0.70 | 9.2 | 87 | 105 |
| E 11 | 1.00 | 0.95 | 9.3 | 88 | 100 |

¹⁾ Based on 100 parts by weight of the total monomers for polymerization in first and second stages and optionally further stages.

The data from table 3 show clearly the increase in viscosity after 14 days of storage of the formulation at 50° C. This increase is the lowest in the case of example 11.

1. A polymer dispersion obtainable by at least two-stage emulsion polymerization
where first in a first stage in aqueous medium a first polymer in dispersion in water and having a glass transition temperature of more than 50° C. and a weight-average molecular weight of between 5 and 100 kDa is prepared by free-radical emulsion polymerization from a first composition comprising hydrophilic and hydrophobic monomers,
comprising
(A1) at least one (meth)acrylic acid alkyl ester,
(B1) optionally at least one vinylaromatic having up to 20 C atoms,
(C1) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D1) at least one α,β-ethylenically unsaturated carboxylic acid, or a vinyl monomer with latent ionic groups,
(E1) optionally at least one crosslinker,
(F1) at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G1) optionally at least one compound having a (meth)acrylate group and an epoxy group, and
(H1) optionally at least one α,β-ethylenically unsaturated carboxamide,
in the presence of at least one initiator, at least one emulsifier, and at least one chain transfer agent,
neutralization to a pH of at least 4.5 of the particles thus formed, using a base (neutralizing agent),
followed by free-radical polymerization of hydrophobic and hydrophilic monomers in a following stage, in the presence of the copolymer prepared in the first stage, from
(A2) at least one (meth)acrylic acid alkyl ester,
(B2) optionally at least one vinylaromatic having up to 20 C atoms,
(C2) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D2) optionally at least one α,β-ethylenically unsaturated carboxylic acid, or a vinyl monomer with latent ionic groups,
(E2) optionally at least one crosslinker, and
(F2) optionally at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G2) optionally at least one compound having a (meth)acrylate group and an epoxy group, and
(H2) optionally at least one α,β-ethylenically unsaturated carboxamide, with the proviso that the polymer of the 2nd stage is more hydrophobic than that of the 1st stage, and the glass transition temperature of the second stage is at least 50° C. lower than that of the first stage.

2. The polymer dispersion according to claim 1, wherein the following stage is followed by further addition of at least one additional crosslinking agent.

3. The polymer dispersion according to claim 2, wherein the monomer (F1) and/or (F2) is selected from diacetoneacrylamide (DAAM) and as crosslinking agent adipic dihydrazide (ADDH).

4. The polymer dispersion according to any of claims 1 to 3, wherein the monomer (A1) and/or (A2) is selected from the group consisting of methyl methacrylate, methyl acrylate, ethyl acrylate, n-butyl acrylate, n-butyl methacrylate, 2-ethylhexyl acrylate, and 3-propylheptyl acrylate.

5. The polymer dispersion according to any of the preceding claims, wherein the monomer (B1) and/or (B2) is selected from the group consisting of styrene and α-methylstyrene.

6. The polymer dispersion according to any of the preceding claims, wherein the monomer (C1) and/or (C2) is selected from the group consisting of fumaronitrile, acrylonitrile, and methacrylonitrile.

7. The polymer dispersion according to any of the preceding claims, wherein the monomers (D1) and/or (D2) are selected from the group of (meth)acrylic acid, crotonic acid, itaconic acid, maleic acid or fumaric acid.

8. The polymer dispersion according to any of the preceding claims, wherein the polymer of the first stage is a copolymer
(i) which is used in an amount of 7% to 80% by weight, based on 100 parts by weight of the total monomers for polymerization in the first and second stages,
(ii) which is synthesized to an extent of at least, e.g., 50% or 60% by weight and up to 99% by weight of principal monomers which are selected from the group of the monomers A1 and B1 and
(iii) 0.1% to 10% by weight of at least one α,β-ethylenically unsaturated carboxylic acid, or vinyl monomer with latent ionic groups (monomers D1),
(iv) 0.1% to 10% by weight of at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM) and diacetonemethacrylamide (monomers F1),
(v) 0% to 10% by weight of at least one compound selected from the group of an α,β-ethylenically unsaturated carboxamide (monomers H1),
(vi) 0% to 10% by weight of at least one compound selected from the monomers C1, E1, and G1,
the quantity figures (ii) to (vi) being based in each case on 100% by weight of the monomers for polymerization in the first stage.

9. The polymer dispersion according to any of the preceding claims, wherein the weight-average molecular weight of the copolymer of the first stage is between 10 and 50 kDa.

10. The polymer dispersion according to any of the preceding claims, wherein the copolymer obtained from the first stage has a glass transition temperature of 50 to 150° C. and the product obtained from the second stage has a glass transition temperature which is lower by at least 50° C.

11. The polymer dispersion according to any of claims 1 to 10, wherein the weight ratio of the monomers used in the first stage to the amount of the monomers used in the second stage is 10:90 to 50:50.

12. A process for preparing a polymer dispersion according to any of the preceding claims, which comprises
carrying out an at least two-stage emulsion polymerization,
where first in a first stage in aqueous medium a first polymer in dispersion in water and having a glass transition temperature of more than 50° C. and a weight-average molecular weight of between 5 and 100 kDa is prepared by free-radical emulsion polymerization, comprising hydrophilic and hydrophobic monomers,
comprising
(A1) at least one (meth)acrylic acid alkyl ester,
(B1) optionally at least one vinylaromatic having up to 20 C atoms,
(C1) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D1) at least one α,β-ethylenically unsaturated carboxylic acid, or a vinyl monomer with latent ionic groups,
(E1) optionally at least one crosslinker,
(F1) at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G1) optionally at least one compound having a (meth)acrylate group and an epoxy group, and
(H1) optionally at least one α,β-ethylenically unsaturated carboxamide,
in the presence of at least one initiator, at least one emulsifier, and at least one chain transfer agent,
neutralization to a pH of at least 4.5 of the particles thus formed, using a base (neutralizing agent),
followed by free-radical polymerization of hydrophobic and hydrophilic monomers in a following stage, in the presence of the copolymer prepared in the first stage, from
(A2) at least one (meth)acrylic acid alkyl ester,
(B2) optionally at least one vinylaromatic having up to 20 C atoms,
(C2) optionally at least one free-radically polymerizable compound selected from the group consisting of ethylenically unsaturated nitriles having up to 20 C atoms, vinyl esters of carboxylic acids comprising up to 20 C atoms, vinyl halides having up to 10 C atoms, and vinyl ethers of alcohols containing 1 to 10 C atoms,
(D2) optionally at least one α,β-ethylenically unsaturated carboxylic acid, or a vinyl monomer with latent ionic groups,
(E2) optionally at least one crosslinker, and
(F2) optionally at least one compound selected from the group consisting of 2-(2-oxoimidazolidin-1-yl)ethyl(meth)acrylate, 2-ureido(meth)acrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM), and diacetonemethacrylamide,
(G2) optionally at least one compound having a (meth)acrylate group and an epoxy group, and
(H2) optionally at least one α,β-ethylenically unsaturated carboxamide, with the proviso that the polymer of the 2nd stage is more hydrophobic than that of the 1st stage, and the glass transition temperature of the second stage is at least 50° C. lower than that of the first stage.

13. A coating material in the form of an aqueous composition comprising at least one polymer dispersion of the invention according to any of claims 1 to 11,
optionally at least one (in)organic filler and/or at least one (in)organic pigment,
optionally at least one customary auxiliary, and
water.

14. The use of a polymer dispersion according to any of claims 1 to 11 for coating compositions.

15. The use of a polymer dispersion according to any of claims 1 to 11 for paints.

16. The use of a polymer dispersion according to any of claims 1 to 11 as paints for wood coatings.
